(19) United States
(12) Patent Application Publication
(10) Pub. No.: US 2020/0176818 A1
(43) Pub. Date: Jun. 4, 2020

(54) NON-AQUEOUS ELECTROLYTE SECONDARY BATTERY

(71) Applicant: Panasonic Intellectual Property Management Co., Ltd., Osaka-shi, Osaka (JP)

(72) Inventors: Satoshi Nishitani, Osaka (JP); Yuji Tani, Osaka (JP); Masaki Deguchi, Hyogo (JP)

(73) Assignee: Panasonic Intellectual Property Management Co., Ltd., Osaka-shi, Osaka (JP)

(21) Appl. No.: 16/639,384

(22) PCT Filed: Sep. 11, 2018
(86) PCT No.: PCT/JP2018/033525

§ 371 Date: Feb. 14, 2020

(30) Foreign Application Priority Data
Sep. 29, 2017 (JP) 2017-191271

(51) Int. Cl. H01M 10/0568; H01M 10/0525; H01M 4/131; H01M 10/0569; H01M 4/485; H01M 10/0567

(52) U.S. Cl. CPC H01M 10/0568; H01M 10/0525; H01M 4/131; H01M 2004/027; H01M 4/485; H01M 10/0567; H01M 10/0569

(57) ABSTRACT

A non-aqueous electrolyte secondary battery, including a positive electrode, a separator, a negative electrode facing the positive electrode with the separator interposed therebetween, and an electrolytic solution including a solvent and an electrolyte. The negative electrode includes a negative electrode material containing a lithium silicate phase and silicon particles dispersed in the lithium silicate phase. The silicon particles are contained in the negative electrode material in an amount of 30 mass % or more, relative to a total mass of the lithium silicate phase and the silicon particles. The electrolytic solution contains an ester compound C of an alcohol compound A and a carboxylic acid compound B, and contains at least one of the alcohol compound A and the carboxylic acid compound B in an amount of 15 ppm or more, relative to a mass of the electrolytic solution.

### TECHNICAL FIELD

The present invention mainly relates to an improvement of an electrolytic solution of a non-aqueous electrolyte secondary battery.

### BACKGROUND ART

A non-aqueous electrolyte secondary battery especially a lithium ion secondary battery, has high voltage and high energy density, and therefore is expected as a power source for small consumer applications, power storage devices, and electric vehicles. With increasing demand for higher energy density of the battery, a material containing silicon that forms an alloy with lithium has been expected to be utilized as a negative electrode active material having high theoretical capacity density.

Patent Literature 1 disperses silicon particles with small particle size in a lithium silicate phase represented by Li_{2z}SiO_{2+z}(0<z<2), thereby to suppress the volume change associated with charge and discharge, and to improve the initial charge-discharge efficiency

On the other hand, Patent Literature 2 uses an ester compound as a solvent of an electrolytic solution, thereby to improve the cycle characteristics.

### CITATION LIST

### Patent Literature

[PTL 1] WO 20161035290
[PLT 2] Japanese Laid-Open Patent Publication No. 2004-172120

### SUMMARY OF INVENTION

In a non-aqueous electrolyte secondary battery including a mixed active material containing silicon pinkies and a lithium silicate phase, increasing the amount of the silicon particles can be expected to result in a high capacity.

Increasing the ratio of silicon particles in the active material, however, causes increased leaching of alkali. In this case, when an electrolytic solution containing an ester compound is used, the decomposition reaction of the ester compound may be accelerated in a high temperature environment. As a result, excellent high-temperature storage characteristics become difficult to obtain.

In view of the above, one aspect of the present invention relates to a non-aqueous electrolyte secondary battery, including a positive electrode, a separator; a negative electrode facing the positive electrode with the separator interposed between the positive electrode and the negative electrode, and an electrolytic solution including a solvent and an electrolyte,

the negative electrode including a negative electrode material containing a lithium silicate phase and silicon particles dispersed in the lithium silicate phase, wherein the silicon particles is contained in the negative electrode material in an amount of 30 mass % or more, relative to a total mass of the lithium silicate phase and the silicon particles,

the electrolytic solution containing an ester compound C of an alcohol compound A and a carboxylic acid compound B, and containing at least one of the alcohol compound A and the carboxylic acid compound B in an amount of 15 ppm or more, relative to a mass of the electrolytic solution.

According to the non-aqueous electrolyte secondary battery of the present invention, excellent high-temperature storage characteristics can be maintained even in a non-aqueous electrolyte secondary battery using a negative electrode material in which silicon particles are dispersed at a high concentration in a lithium silicate phase.

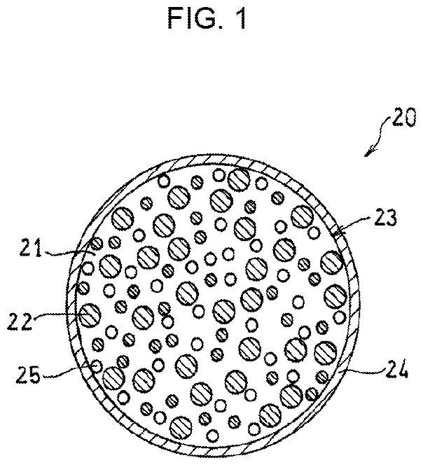

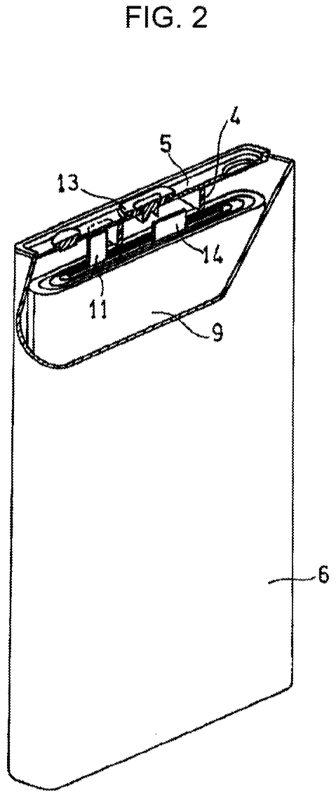

### BRIEF DESCRIPTION OF DRAWINGS

[FIG. 1] A schematic cross-sectional diagram of an LSX particle according to one embodiment of the present invention.

[FIG. 2] A schematic partially cut-away oblique view of a non-aqueous electrolyte secondary battery according to one embodiment of the present invention.

### DESCRIPTION OF EMBODIMENTS

A non-aqueous electrolyte secondary battery according to an embodiment of the present invention includes a positive electrode, a separator, a negative electrode facing the positive electrode with the separator interposed therebetween, and an electrolytic solution including a solvent and an electrolyte. The negative electrode includes a negative electrode material. The negative electrode material contains a lithium silicate phase and silicon particles dispersed in the lithium silicate phase (hereinafter sometimes referred to as “negative electrode material LSX” or simply “LSX”). The silicon particles are contained in the negative electrode material in an amount of 30 mass % or more, relative to a total mass of the lithium silicate phase and the silicon particles (i.e. a whole mass of the negative electrode material LSX).

The lithium silicate phase preferably has a composition represented by Li_{y}SiO_{z}, where 0<y≤4, and 0.2≤z≤5, more preferably has a composition represented by Li₂ₙSiO₂₊ₙ, where 0<u<2.

In the lithium silicate phase, the sites that can react with lithium are scarce as compared with in SiOₓ which is a composite of SiO₂ and fine silicon. The lithium silicate phase, therefore, is less likely to generate irreversible capacity associated with charge and discharge. When silicon particles are dispersed in the lithium silicate phase, excellent charge-discharge efficiency can be obtained at an early stage of charge and discharge. Moreover, the amount of silicon particles can be changed as desired, and thus, the negative electrode can be designed to have a high capacity.

The crystallite size of the silicon particles dispersed in the lithium silicate phase is, for example, 10 nm or more. The silicon particles have a particulate phase of silicon (Si) elementary substance. When the crystallite size of the silicon particles is 10 nm or more, the surface area of the silicon particles can be suppressed small. Therefore, the silicon particle deterioration accompanied by generation of irreversible capacity is unlikely to occur. The crystallite size of the silicon particles can be calculated from the Scherrer formula, using a half-width of a diffraction peak attributed to the Si (111) plane of an X-ray diffractometry pattern of the silicon particle.

Note that SiOₓ is a composite of SiO₂ and fine silicon having a crystallite size of 5 nm or so, and contains much SiO₂. Therefore, for example, the following reaction occurs during charge and discharge.

SiOₓ(2Si+2SiO₂)+16Li⁺+16e⁻→3Li₄Si+Li₄SiO₄ (1)

Breaking down the formula (1) for Si and 2SiO₂ gives the following formula

Si+4Li⁺+4e⁻→Li₄Si (2)

2SiO₂+8Li⁺+8e⁻→Li₄Si+Li₄SiO₄ (3)

The reaction of SiO₂ of the formula (3) is irreversible, and the production of Li₄SiO₄ is a major cause of the reduction in initial charge-discharge efficiency,

The negative electrode material LSX is excellent also in structural stability. This is because silicon particles are dispersed in the lithium silicate phase, and this suppresses the expansion and contraction of the negative electrode material LSX associated with charge and discharge. In view of suppressing the cracking of the silicon particles themselves, the average particle diameter of the silicon particles before the first charge is preferably 500 nm or less, more preferably 200 nm or less, still more preferably 50 nm or less. After the first charge, the average particle diameter of the silicon particles is preferably 400 nm or less, more preferably 100 nm or less. Finer silicon particles can reduce the changes in volume during charge and discharge, and thereby can further improve the structural stability of the negative electrode material LSX.

The average particle diameter of the silicon particles can be measured by observing a cross-sectional SEM (scanning electron microscope) photograph of the negative electrode material LSX. Specifically, the average particle diameter of the silicon particles can be determined by averaging the maximum diameters of randomly selected 100 silicon particles. The silicon particle is an aggregate of crystallites.

The amount of the silicon particles dispersed in the lithium silicate phase is preferably 20 mass % or more relative to the mass of the whole negative electrode material LSX, more preferably 35 mass % or more relative to the mass of the whole negative electrode material LSX, in view of achieving a high capacity. This also facilitates the diffusion of lithium ions, tending to achieve excellent load characteristics. On the other hand, in view of improving the cycle characteristics, the amount of silicon particles is preferably 95 mass % or less relative to the mass of the whole negative electrode material LSX, more preferably 75 mass % or less relative to the mass of the whole negative electrode material LSX. This reduces the exposed surface of the silicon particles exposed without covered with the lithium silicate phase, suppressing the side reaction between the non-aqueous electrolyte and the silicon particles. The amount of the silicon particles can be m by Si-NMR.

Desirable Si-NMR measuring conditions are shown below.

Measuring apparatus: solid nuclear magnetic resonance spectrometer. (INOVA-400), available from Varian, Inc.

Probe: Varian 7 mm CPMAS-2

MAS: 4.2 kHz

MAS speed: 4 kHz

Pulse: DD (45° pulse+signal capture time 1H decoupling)

Repetition time: 1200 sec

Observation width: 100 kHz

Observation center: around −100 ppm

Signal capture time: 0.05 sec

Number of times of accumulation: 560

Sample amount: 207.6 mg

On the other hand, when the amount of the silicon particles exceeds 30 mass % relative to the mass of the whole LSX, the leaching of the alkali component increases. In this case, when an electrolytic solution containing an ester compound is used, the ester compound tends to decompose into alcohol and carboxylic acid, especially in a high temperature environment,

The electrolytic solution contains, as a solvent, the ester compound C of an alcohol compound A and a carboxylic acid compound B. When the silicon particles are contained at a high concentration in the LSX, since this forms a strong alkali environment, the decomposition reaction of the ester compound C may be accelerated under high temperatures (specifically, 60° C. or higher). As a result, high capacity cannot be maintained in a high temperature environment.

To address the above, the electrolytic solution of the non-aqueous electrolyte secondary battery includes, in addition to the ester compound C, at least one of the alcohol compound A and the carboxylic acid compound B. By adding a decomposition product of the ester compound C, i.e., the alcohol compound A and/or the carboxylic acid compound B, into the electrolytic solution in advance, the equilibrium of the esterification reaction shifts toward the production side of the ester compound C, according to the Le Chatelier's principle. This can suppress the decomposition reaction of the ester compound C.

The amount of the alcohol compound A and/or the carboxylic acid compound B in the electrolytic solution at the time of preparation is 1 ppm or more, relative to the mass of the electrolytic solution. When the amount of the alcohol compound A and/or the carboxylic acid compound B in the electrolytic solution at the time of preparation is 1 ppm or more, the decomposition of the ester compound C can be sufficiently suppressed. The amount of the alcohol compound A in the electrolytic solution at the time of preparation is preferably 2 to 1000 ppm, more preferably 5 to 500 ppm, still more preferably 10 to 100 ppm, relative to the mass of the electrolytic solution. Likewise, the amount of the carboxylic acid compound B in the electrolytic solution at the time of preparation is preferably 2 to 1000 ppm, more preferably 5 to 500 ppm still more preferably 10 to 100 ppm.

The amount of the alcohol compound A and/or the carboxylic acid compound B in the electrolytic solution in the non-aqueous electrolyte secondary battery after production is likely to increase (approx. 10 ppm or so) from that in the electrolytic solution upon preparation. Preferably, in the battery in an initial state having undergone about 10 charge-discharge cycles or less, the amount of the alcohol compound A and/or the carboxylic acid compound B is, for each compound, 15 ppm or more, more preferably 15 to 1000 ppm, still more preferably 20 to 1000 ppm, relative to the mass of the electrolytic solution.

The amount of the alcohol compound A and the carboxylic acid compound B can be measured by taking out the electrolytic solution from the battery, and using a gas chromatography mass spectrometry.

Note that the carboxylic acid compound B can be present not only in the form of R—COOH (R is an organic functional group) in the electrolytic solution, but also in the form of a carboxylate ion (R—COO⁻) or, in an alkali environment in the form of a Li salt (R—COOLi). The amount of the carboxylic acid compound B is calculated with taking, into account these compounds present in the form of a carboxylate ion or a salt.

The alcohol compound A preferably includes at least one selected from the group consisting of monoalcohols having 1 to 4 carbon atoms, and more preferably includes methanol. The carboxylic acid compound B preferably includes at least one selected from the group consisting of monocarboxylic acids having 2 to 4 carbon atoms, and more preferably includes acetic acid.

Therefore, the ester compound C most preferably includes methyl acetate.

The ester compound C is contained preferably in an amount of 1 to 80%, relative to the volume of the electrolytic solution.

The composition of the lithium silicate phase Li_{y}SiO_{z} can be analyzed, for example, by the following method.

First, the mass of a sample of the negative electrode material LSX is measured. Thereafter, the carbon, lithium, and oxygen contents in the sample are calculated as described below. Next, the carbon content is subtracted from the mass of the sample, to calculate the lithium and oxygen contents in the rest mass. The y and z ratios can be determined from the molar ratio of lithium (Li) to oxygen (O).

The carbon content can be measured using a carbon/sulfur analyzer (e.g. EMIA-520 available from HORIBA, Ltd.). A sample is weighed out on a magnetic board, to which an auxiliary agent is added. The sample is inserted into a combustion furnace (carrier gas: oxygen) heated to 1350° C. The amount of carbon dioxide gas generated during combustion is detected by infrared absorption spectroscopy. A calibration curve is obtained using carbon steel (carbon content: 0.49%) available from Bureau ofAnalvsed Samples Ltd., from which a carbon content in the sample is determined (a high-frequency induction heating furnance combustion and infrared absorption method).

The oxygen content can be measured using an oxygen/nitrogen/hydrogen analyzer (e.g., EGMA-830, available from HORIBA, Ltd.). A sample is placed in a Ni capsule and put together with Sn pellets and Ni pellets serving as flux, into a carbon crucible heated at a power of 5.75 kW, to detect a produced carbon monoxide gas. From a calibration curve obtained using a standard sample Y₂O₃, an oxygen content in the sample is determined (an inert gas melting and non-dispersive inflated absorption method).

The lithium content can be measured as follows: a sample is completely dissolved in a heated fluoronitric acid (a heated mixed acid of hydrofluoric acid and nitric acid), followed by filtering to remove an undissolved residue. i.e., carbon, and then analyzing the obtained filtrate by inductively coupled plasma emission spectroscopy (ICP-AES). From a calibration curve obtained using a commercially available standard solution of lithium, a lithium content in the sample is determined.

Subtracting the carbon content, the oxygen content, and the lithium content from the mass of the sample of the negative electrode material LSX gives a silicon content. This silicon content involves a contribution of both silicon present in the form of silicon particles and that present in the form of lithium silicate. The amount of silicon particles can be determined by Si-NMR measurement, and this determines the amount of the silicon present in the form of lithium silicate in the negative electrode material LSX.

The negative electrode material LSX is preferably a particulate material having an average particle diameter of preferably 1 to 25 μm, more preferably 4 to 15 μm (hereinafter sometimes referred to as LSX particles). When the particle diameter is within the range above, the stress caused by changes in volume of the negative electrode material LSX associated with charge and discharge is likely to he reduced, and thus, excellent cycle characteristics tend to be obtained. Also, the LSX particles tend to have a moderate surface area, and the reduction in capacity due to a side reaction with the non-aqueous electrolyte can be suppressed.

The average particle diameter of the LSX particles means a particle diameter at 50% cumulative volume (volume average particle diameter) in a volumetric particle diameter distribution measured by a laser diffraction and scattering method. For the measurement, for example, “LA-750”, available from Horiba, Ltd. (HORIBA) can be used.

The LSX particles are preferably each include an electrically conductive material covering part of its surface. The lithium silicate phase is poor in electron conductivity. The electric conductivity of the LSX particles therefore tends to be low. By covering the surface with the conductive material, the conductivity can be improved significantly. The conductive layer is preferably thin enough not to substantially influence the average particle diameter of the LSX particles.

Next, a description will be given of a method for producing the negative electrode material LSX.

The negative electrode material LSX is synthesized basically through two processes: a pre-process of obtaining a lithium silicate, and a post-process of obtaining a negative electrode material LSX from the lithium silicate and a taw material silicon. Specifically, the production method of the negative electrode material LSX includes (i) a step of mixing silicon dioxide and a lithium compound, and sintering the resultant mixture to obtain a lithium silicate; and (ii) a step of forming a composite of the lithium silicate and a raw material silicon, to obtain a negative electrode material LSX containing a lithium silicate phase and silicon particles dispersed in the lithium silicate phase.

The value u in the lithium silicate represented by a formula: Li₂ᵤSiO₂₊ᵤ may be controlled by the atomic ratio: Li/Si of lithium to silicon in the mixture silicon dioxide and lithium compound. In order to synthesize, a good quality lithium silicate that shows little leaching of alkali components, the Li/Si is preferably less than 1.

Examples of the lithium compound include lithium carbonate, lithium oxide, lithium hydroxide, and lithium hydride. These may be used singly or in combination of two or more kinds.

The mixture of silicon dioxide and lithium compound is heated in air at 400° C. to 1200° C. more preferably at 800° C. to 1100° C., to allow the silicon dioxide to read with the lithium compound.

Next, a composite of the lithium silicate and a raw material silicon is formed. For example, while a shear three is applied to a mixture of the lithium silicate and a raw material, the mixture is pulverized. The raw material silicon may he coarse particles of silicon having an average particle diameter of several μm to several tens μm or so. The finally obtained silicon particles are preferably controlled so as to have a crystallite size of 10 nm or more, where the crystallite size is calculated from the Scherrer formula using a half-width of a diffraction peak attributed to the Si (111) plane of an XRD pattern.

For example, the lithium silicate and a raw material silicon are mixed at a predetermined mass ratio, and the mixture is stirred while being pulverized into very small particles, using a pulverizing machine, such as a ball mill. The process of forming a composite is not limited thereto. For example, without using a pulverizing machine, silicon nanoparticles and lithium silicate nanoparticles may be synthesized separately, and they may be mixed.

Next, the mixture pulverized into very small particles is heated at 450° C. to 1000° C. in, for example, an inert atmosphere (e.g., argon or nitrogen atmosphere), to be sintered. The mixture may be heated with pressure applied by a hot press or the like, to form a sintered body of the mixture (negative electrode material LSX). The lithium silicate is stable and hardly reacts with silicon at 450° C. to 1000° C.; therefore, the reduction in capacity, if occurred, is very small.

The sintered body is then pulverized into granules, which can be used as the LSX particles. Here, by selecting the pulverizing conditions as appropriate. LSX particles having an average particle diameter of, for example, 1 to 25 μm can be obtained.

Next, the surfaces of the LSX particles may be at least partially coated with an electrically conductive material, to form an electrically conductive layer thereon. The conductive material is preferably electrochemically stable. A preferable example of the conductive material is a carbon material. Examples of a method of coating a particulate material with a carbon material include: a CVD method using a hydrocarbon gas, such as acetylene or methane, as a raw material; and a method in which a particulate material is mixed with coal pitch, petroleum pitch, phenol resin, or the like, followed by heating and carbonizing. In another exemplary method, carbon black may be allowed to adhere to the surface of a particulate material.

The thickness of the conductive layer is preferably 1 to 200 nm, more preferably 5 to 100 nm, for seeming the conductivity and allowing for diffusion of lithium ions. The thickness of the conductive layer can be measured by cross-section observation of the particles using SEM or TEM.

The LSX particles may be washed with an acid. For example, washing the LSX particles with an acidic aqueous solution can dissolve and remove a trace amount of Li₂SiO₃ or other components which may have been possibly produced in the process of forming a composite material of a raw material silicon and the lithium silicate. Examples of the acidic aqueous solution include: an aqueous solution of an inorganic acid, such as hydrochloric acid, hydrofluoric acid, sulfuric acid, nitric acid, phosphoric acid, or carbonic acid; and an aqueous solution of an organic acid, such as citric acid or acetic acid.

A cross section of one of LSX particles 20, which is an example of the negative electrode material LSX, is schematically shown in FIG. 1.

The LSX particle 20 includes a lithium silicate phase 21 and silicon particles 22 dispersed in the lithium silicate phase. An electrically conductive layer 24 is formed on a surface of a base particle 23 constituted of the lithium silicate phase 21 and the silicon particles 22. The conductive layer 24 is formed of an electrically conductive material covering at least part of the surface of the LSX particle or the base particle 23. The LSX particle 20 may further include particles 25 containing element Me and dispersed in the lithium silicate phase. The element Me is at least one selected from the group consisting of rare earth elements and alkaline earth elements, and is preferably at least one selected from the group consisting of Y, Ce, Mg and Ca. The element Me is present in the particle 25, for example, in an oxide state, and suppresses the side reaction of the lithium silicate phase and/or silicon particles with the non-aqueous electrolyte.

The base particle 23 has, for example, a sea-island structure, and in a randomly selected cross section thereof, fine silicon (elementary Si) particles 22 and fine particles 25 containing element Me are substantially uniformly distributed without being localized, within the matrix of the lithium silicate phase 21.

The lithium silicate phase 21 is preferably composed of particles finer than the silicon particles 22. In this case, in an X-ray diffraction (XRD) pattern of the LSX particle 20, the diffraction peak intensity attributed to the (111) plane of elementary Si is larger than that attributed to the (111) plane of the lithium silicate.

The base particle 23 may thither contain a component other than the lithium silicate phase 21, the silicon particles 22, and the Me-containing particles 25 or a compound of a third metal. For example, the lithium silicate phase 21 may contain, in addition to the lithium silicate, SiO₂ in an amount like that of the natural oxide film to be formed on the surface of the silicon particles. The amount of SiO₂ in the base particle 23 measured by Si-NMR is preferably 30 mass % or less, more preferably 7 mass % or less. In an XRD pattern obtained by XRD measurement, it is preferable that no peak of SiO₂ is substantially observed at 2θ=25°.

A detailed description will be given below of a non-aqueous electrolyte secondary battery according to an embodiment of the present invention. The non-aqueous electrolyte secondary battery includes, for example, a negative electrode, a positive electrode, and a non-aqueous electrolyte as described below.

[Negative Electrode]

The negative electrode includes, for example, a negative electrode current collector, and a negative electrode mixture layer formed on a surface of the negative electrode current collector and containing a negative electrode active material. The negative electrode mixture layer can be formed by applying a negative electrode slurry of a negative electrode mixture dispersed in a dispersion medium, onto a surface of the negative electrode current collector, and drying the slurry. The dry applied film may be rolled, if necessary. The negative electrode mixture layer may be formed on one surface or both surfaces of the negative electrode current collector.

The negative electrode mixture includes a negative electrode material LSX (or LSX particles) as an essential component, and may include a binder, an electrically conductive agent, a thickener, and other optional components. The silicon particles in the negative electrode material LSX can absorb a lot of lithium ions, and therefore, can contribute to an increase in the capacity of the negative electrode.

The negative electrode active material preferably further includes a carbon material that electrochemically absorbs and releases lithium ions. The negative electrode material LSX expands and contracts in volume in association with charge and discharge. Therefore, increasing the ratio thereof in the negative electrode active material may cause a contact failure between the negative electrode active material and the negative electrode current collector, in association with charge and discharge. On the other hand, by using the negative electrode material LSX and a carbon material in combination, a high capacity of the silicon particles can be imparted to the negative electrode, and excellent cycle characteristics can be achieved. The ratio of the negative electrode material LSX to the total of the negative electrode material LSX and the electrode material is preferably, for example, 3 to 30 mass %. In this case, a higher capacity as well as improved cycle characteristics tend to be achieved.

Examples of the carbon material include graphite, graphitizable carbon (soft carbon), and non-graphitizable carbon (hard carbon). Preferred among them is graphite, which is stable during charge and discharge cycles and whose irreversible capacity is small. The graphite means a material having a graphite-like crystal structure, examples of which include natural graphite, artificial graphite, and graphitized mesophase carbon particles. The carbon material may be used singly or in combination of two or more kinds.

Examples of the negative electrode current collector includes a non-porous electrically conductive substrate (e.g., metal foil) and a porous electrically conductive substrate (e.g., mesh, net, punched sheet). The negative electrode current collector may be made of, for example, stainless steel, nickel, a nickel alloy, copper, or a copper alloy. The negative electrode current collector may have any thickness. In view of balancing between maintaining the strength and reducing the weight of the negative electrode, the thickness is preferably 1 to 50 μm, more preferably from 5 to 20 μm.

The binder may be a resin material, examples of which include: fluorocarbon resin, such as polytetrafluoroethylene and poly vinylidene fluoride (PVDF); polyolefin resin, such as polyethylene and polypropylene; polyamide resin, such as aramid resin; polyimide resin, such as polyimide and polyamide-imide, acrylic resin, such as polyacrylic acid, polymethyl acrylate, and ethylene-acrylic acid copolymer; vinyl resin, such as polyacrylnitrile and polyvinyl acetate; polyvinyl pyrrolidone; polyether sulfone; and a rubbery material, such as styrene-butadiene copolymer rubber (SBR). These may be used singly or in combination of two or more kinds.

Examples of the conductive agent include: carbon blacks, such as acetylene black, conductive fibers, such as carbon fibers and metal fibers; fluorinated carbon: metal powders, such as aluminum; conductive whiskers, such as zinc oxide and potassium titanate; conductive metal oxides, such as titanium oxide; and organic conductive materials such as phenylene derivatives. These may be used singly or in combination of two or more kinds.

Examples of the thickener include: carboxymethyl cellulose (CMC) and modified products thereof (including salts, such as Na salt); cellulose derivatives (e.g., cellulose ether), such as methyl cellulose; saponificated products of a polymer having a vinyl acetate unit, such as polyvinyl alcohol; polyether (e.g., polyalkylene oxide, such as polyethylene oxide). These may be used singly or in combination of two or more kinds.

Examples of the dispersion medium include: water; alcohols, such as ethanol; ethers, such as tetrahydrofuran; amides, such as dimethylformamide; N-methyl-2-purrolidone (NMP); and a mixed solvent of these.

[Positive Electrode]

The positive electrode includes, for example, a positive electrode current collector, and a positive electrode mixture layer formed on a surface of the positive electrode current collector. The positive electrode mixture layer can be formed by applying a positive electrode slurry of a positive electrode mixture in a dispersion medium, onto a surface of the positive electrode current collector, and drying the slurry. The dry applied film may be rolled, if necessary. The positive electrode mixture layer may be formed on one surface or both surfaces of the positive electrode current collector.

The positive electrode active material may be a lithium composite metal oxide. Examples thereof include LiₐCoO₂, LiₐNiO₂, LiₐMnO₂, LiₐCo_{b}Ni_{1-b}O₂, LiₐCo_{b}M_{1-b}O_{c}, LiₐNi_{1-b}M_{b}O_{c}, LiₐMn₂O₄, LiₐMn_{2-b}M_{b}O₄, LiMPO₄ and Li₂MPO₄F (M represents at least one selected from Na, Mg, Sc, Y, Mn, Fe, Co, Cu, Zn, Al, Cr, Ph, Sb and B). Here, a=0 to 1.2, b=0 to 0.9, c=2.0 to 2.3. The value “a” representing the molar ratio of lithium is measured upon production of the active material and is subjected to increase and decrease during charge, and discharge.

Preferred among them is a lithium-nickel composite oxide represented by LiₐNi_{b}M_{1-b}O₂ (M represents at least one selected from Mn, Co and Al, 0<a≤1.2, and 0.3≤b≤1). In view of achieving a high capacity, b preferably satisfies 0.85≤b≤1. In view of the stability of the crystal structure, more preferred is LiₐNi_{b}Co_{c}Al_{d}O₂ containing Co and Al as elements represented by M (0<a≤1.2, 0.85≤b<1, 0<c<0.15, 0<d≤0,1, b+c+d=1).

Examples of the lithium-nickel composite oxide include a lithium-nickel-cobalt-manganese composite oxide (e.g., LiNi_{0.5}Co_{0.2}Mn_{0.3}O₂, LiNi_{1/3}Co_{1/3}Mn_{1/3}O₂, LiNi_{0.4}Co_{0.2}Mn_{0.4}O₂), a lithium-nickel-manganese composite oxide (LiNi_{0.5}Mn_{0.5}O₂), a lithium-nickel-cobalt composite oxide (LiNi_{0.8}Co_{0.2}O₂), and a lithium-nickel-cobalt-aluminum composite oxide (LiNi_{0.8}Co_{0.15}Al_{0.05}O₂, LiNi_{0.8}Co_{0.18}Al_{0.02}O₂, LiNi_{0.5}Co_{0.05}Al_{0.05}O₂).

Examples of the binder and the conductive agent are as those exemplified for the negative electrode. The conductive agent may be gaphite, such as natural graphite and artificial graphite.

The form and the thickness of the positive electrode current collector may be respectively selected from the forms and the range corresponding to those of the negative electrode current collector. The positive electrode current collector may be made of, for example, stainless steel, aluminum, an aluminum alloy, and titanium.

[Non-Aqueous Electrolyte]

The non-aqueous electrolyte contains a non-aqueous solvent, and a lithium salt dissolving in the non-aqueous solvent. The concentration of the lithium salt in the non-aqueous electrolyte is, for example, 0.5 to 2 mo/L. The non-aqueous electrolyte may contain a known additive.

The non-aqueous solvent may be, in addition to the chain carboxylic acid ester compound C as above, for example, a cyclic carbonic acid ester, a chain carbonic acid ester, or a cyclic carboxylic acid ester. Examples of the cyclic carbonic acid ester include propylene carbonate (PC) and ethylene carbonate (EC). Examples of the chain carbonic acid ester include diethyl carbonate (DEC) ethyl methyl carbonate (EMC), and dimethyl carbonate (DMC). Examples of the cyclic carboxylic acid ester include γ-butyrolactone (GBL) and γ-valerolactone (GVL). These non-aqueous solvents may be used singly or in combination of two or more kinds.

Examples of the lithium salt include a lithium salt of a chlorine-containing acid (e.g., LiClO₄, LiAlCl₄, LiB₁₀Cl₁₀), a lithium salt of a fluorine-containing acid (e.g., LiPF₆, LiBF₄, LiSbF₆, LiAsF₆, LiCF₃SO₃, LiCF₃CO₂), a lithium salt of a fluorine-containing acid imide (e.g., LiN(CF₃SO₂)₂, LiN(CF₃SO₂)(C₄F₉SO₂), LiN(C₂F₅SO₂)₂), and a lithium halide (e.g., LiCl, LiBr, LiI). These lithium salts may be used singly or in combination of two or more kinds.

[Separator]

Usually, it is desirable to interpose a separator between the positive electrode and the negative electrode. The separator is excellent in ion permeability and has moderate mechanical strength and electrically insulating properties. The separator may be, for example, a microporous thin film, a woven fabric, or a nonwoven fabric. The separator is preferably made of, for example, polyolefin, such as polypropylene or polyethylene.

In an exemplary structure of the non-aqueous electrolyte secondary battery, an electrode group formed by winding the positive electrode and the negative electrode with the separator interposed therebetween is housed together with the non-aqueous electrolyte in an outer case. The wound-type electrode group may be replaced with a different form of the electrode group, for example, a stacked-type electrode group formed by stacking the positive electrode and the negative electrode with the separator interposed therebetween. The non-aqueous electrolyte secondary battery may be in any form, such as cylindrical type, prismatic type, coin type, button type, or laminate type.

FIG. 2 is a schematic partially cut-away oblique view of a non-aqueous electrolyte secondary battery according to an embodiment of the present invention. The battery includes a bottomed prismatic battery case 6, and an electrode group 9 and a non-aqueous electrolyte (not shown) housed in the battery case 6. The electrode group 9 has a long negative electrode, a long positive electrode, and a separator interposed between the positive electrode and the negative electrode and preventing them from directly contacting with each other. The electrode group 9 is framed by winding the negative electrode, the positive electrode, and the separator around a flat plate-like winding core, and then removing the winding core.

A negative electrode lead 11 is attached at its one end to the negative electrode current collector of the negative electrode, by means of welding or the like. A positive electrode lead 14 is attached at its one end to the positive electrode current collector of the positive electrode, by means of welding or the like. The negative electrode lead 11 is electrically connected at its, other end to a negative electrode terminal 13 disposed at a sealing plate 5. The positive electrode lead 14 is electrically connected at its other end to a battery case 6 serving as a positive electrode terminal. A resin frame member 4 is disposed on top of the electrode group 9, the frame member serving to insulate the electrode group 9 from the sealing plate 5, as well as to insulate the negative electrode lead 11 from the battery case 6. The opening of the battery case 6 is sealed with the sealing plate 5.

The non-aqueous electrolyte secondary battery may be of cylindrical, coin, or button type having a battery case made of metal, or of laminate type having a battery case made of a laminated sheet which is a laminate of a barrier layer and a resin sheet.

The present invention will be specifically described below with reference to Examples and Comparative Examples. It is to be noted, however, the present invention is not limited to the following Examples.

### EXAMPLE 1

[Preparation of Negative Electrode Material LSX]

Silicon dioxide was mixed with lithium carbonate such that the atomic ratio: Si/Li become 1.05. The mixture was heated in air at 950° C. for 10 hours, to obtain a lithium silicate represented by a formula: Li₂Si₂O₅ (u=0.5). The obtained lithium silicate was pulverized to have an average particle diameter of 10 μm.

The lithium silicate (Li₂Si₂O₅) having an average particle diameter of 10 μm and a raw material silicon (3N, average particle diameter: 10 μm) were mixed at a mass ratio of 45:55. The mixture was placed in a pot (made of SUS, volume: 500 mL) of a planetary ball mill (P-5, available from Fritsch Co., Ltd), together with 24 SUS balls (diameter: 20 mm). In the pot with the lid closed, the mixture was pulverized at 200 rpm for 50 hours in an inert atmosphere.

Next, the powdered mixture was taken out from the pot in an inert atmosphere, which was then sintered at 800° C. for 4 hours, in an inert atmosphere, with a predetermined pressure applied by a hot press, to give a sintered body of the mixture (LSX particles (base particles)).

Thereafter, the LSX particles were pulverized and passed through a 40-μm mesh, and then mixed with a coal pitch (MCP 250, available from JFE Chemical Corporation). The mixture was heated at 800° C. in an inert atmosphere, to coat the LSX particles with an electrically conductive carbon, so that a conductive layer was formed on the particle surfaces. The amount of the conductive layer was 5 mass % relative to the total mass of the LSX particles and the conductive layer. Thereafter, a sieve was used to obtain LSX particles having the conductive layer and having an average particle diameter of 5 μm.

[Analysis of LSX Particles]

The crystallite size of the silicon particles calculated from the Scherrer formula, from a diffraction peak attributed to the Si (111) plane obtained by XRD analysis of the LSX particles was 15 nm.

The composition of the lithium silicate phase was analyzed by the method as above (high-frequency induction heating furnace combustion and infrared absorption method, inert gas melting and non-dispersion type infrared absorption method, inductively coupled plasma emission spectroscopy (ICP-AES)). The result showed that the Si/Li ratio was 1.0, and the amount of Li₂Si₂O₅ measured by Si-NMR was 45 mass % (the amount of silicon particles was 55 mass %).

[Production of Negative Electrode]

The LSX particles having the conductive layer were mixed with graphite in a mass ratio of 5:95, and the resultant mixture was used as a negative electrode active material. The negative electrode active material was mixed with sodium :carboxymethyl cellulose (CMC-Na) and styrene-butadiene rubber (SBR) in a mass ratio of 97.5:1:1.5, to which water was added. The mixture was stirred in a mixer (T.K. HIVIS MIX, available from PRIMIX Corporation), to prepare a negative electrode slurry. Next, the negative electrode slurry was applied onto copper foil, so that the mass of a negative electrode mixture per 1 m² of the copper foil was 190 g. The applied film was dried, and then rolled, to give a negative electrode with a negative electrode mixture layer having a density of 1.5 g/cm³ formed on both sides of the copper foil.

[Production of Positive Electrode]

A lithium-nickel composite oxide LiNi_{0.5}Co_{0.2}Mn_{0.3}O₂ was mixed with acetylene black and polyvinylidene fluoride in a mass ratio of 95:2.5:2.5, to which N-methyl-2-pyrrolidone (NMP) was added. The mixture was stirred in a mixer (T.K HIVIS MIX, available from PRIMIX Corporation), to prepare a positive electrode slurry. Next, the positive electrode slurry was applied onto aluminum foil. The applied film was dried, and then rolled, to give a positive electrode with a positive electrode mixture layer having a density of 3.6 g/cm³ formed on both sides of the aluminum foil.

[Preparation of Non-Aqueous Electrolytic Solution]

A mixed solvent containing ethylene carbonate (EC), dimethyl carbonate (DMC), ethyl methyl carbonate (EMC), and methyl acetate serving as an ester compound C in a volume ratio of 20:68:10:2 was prepared. To the mixed solvent, methanol serving as an alcohol compound A, and acetic acid serving as a carboxylic acid compound B were added each at a concentration of 2 ppm, relative to the total mass of the solution, to prepare a non-aqueous electrolyte solution. The methyl acetate had a purity of 99.9999%.

[Fabrication of Non-Aqueous Electrolyte Secondary Battery]

The positive electrode and the negative electrode, with a tab attached to each electrode, were wound spirally with a separator interposed therebetween such that the tab was positioned at the outermost layer, thereby to form an electrode group. The electrode group was inserted into an outer case made of aluminum laminated film and dried under vacuum at 105° C. for 2. hours. The non-aqueous electrolytic solution was injected into the case, and the opening of the outer case was sealed. A battery A1 was thus obtained.

### EXAMPLES 2 TO 8

The alcohol compound A, the carboxylic acid compound B, and the ester compound C. were each added in an amount as shown in Table 1, to prepare an electrolytic solution. In Examples 2 to 8, while increasing or decreasing the amount of the ester compound C in the electrolytic solution, the amount of dimethyl carbonate (DMC) was decreased or increased. A positive electrode and a negative electrode were prepared, and batteries A2 to A8 of Examples 2 to 8 were fabricated in the same manner as in Example 1 except the above.

### COMPARATIVE EXAMPLE 1

An electrolytic solution was prepared such that ethylene carbonate (EC), dimethyl carbonate (DMC), and ethyl methyl carbonate (EMC) were contained in a volume ratio of 20:70:10. The alcohol compound A, the carboxylic acid compound B, and the ester compound C were not added to the electrolytic solution. A positive electrode and a negative electrode were prepared, and a battery B1 of Comparative Example 1 was fabricated in the same manner as in Example 1 except the above.

### COMPARATIVE EXAMPLE 2

An electrolytic solution was prepared such that ethylene carbonate (EC), dimethyl carbonate (DMC), ethyl methyl carbonate (EMC), and methyl acetate serving as the ester compound C were contained in a volume ratio of 20:60:10:10. The alcohol compound A and the carboxylic acid compound B were not added to the electrolytic solution. A positive electrode and a negative electrode were prepared, and a battery B2 of Comparative Example 2 was fabricated in the same manner as in Example 1 except the above.

### COMPARATIVE EXAMPLE 3

Lithium silicate (Li₂Si₂O₅) Laving an average particle diameter of 10 μm and a raw material silicon (3N, average particle diameter: 10 μm) were mixed in a mass ratio of 75:25 to prepare a negative electrode material LSX. A negative electrode material LSX was synthesized in the same manner as in Example 1 except the above. The amount of Li₂Si₂O₅ measured by Si-NMR was 75 mass % (the amount of silicon particles was 25 mass %).

LiNi_{0.5}Co_{0.2}Mn_{0.3}O₂ was used as the positive electrode material. The alcohol compound A, the carboxylic acid compound B, and the ester compound C were added each in an amount as shown in Table 1, to prepare an electrolytic solution. Ethylene carbonate (EC), ethyl methyl carbonate (EMC) and methyl acetate serving as the ester compound C were contained in a volume ratio of 20:45:10:25. A positive electrode and a negative electrode were produced, and a battery B3 of Comparative Example 3 was fabricated in the same manner as in Example 1 except the above.

[Analysis of Electrolytic Solution in Battery]

The fabricated batteries were each subjected to a constant-current charge at a current of 0.3. It (800 mA) until the voltage readied 4.2 V and then to a constant-voltage charge at a voltage of 4.2 V until the current reached 0.015 It (40 mA). Thereafter, the batteries were subjected to a constant-current discharge at 0.3 It (800 mA) until the voltage reached 2.75 V

With the rest time between charge and discharge set to 10 minutes, charge and discharge were repeated 5 cycles in total under the charge and discharge conditions as mentioned above. Thereafter, the batteries were disassembled, to analyze the components of the electrolytic solution by gas chromatography mass spectrometry (GCMS). The amounts of the alcohol compound A and the carboxylic acid compound B (the mass ratio to the whole electrolyte) obtained by the analysis are shown in Table 1.

The GCMS measurement conditions used for the analysis of the electrolytic solution were as follows.

Apparatus: GC 17A, GCMS-QP5050A, available from Shimadzu Corporation

Column: HP-1 (film thickness: 1.0 μm×length 60 m), available horn Agilent Technologies, Inc.

Column temperature: 50° C.→110° C. (5° C./min, hold 12 min)→250° C. (5° C./min, hold 7 min)→300 (10° C./min, hold 20 min)

Split ratio: 1/50

Linear velocity: 29.2 cm/s

Inlet temperature: 270° C.

Injection amount: 0.5 μL

Interface temperature: 230° C.

Mass range: m/z=30 to 400 (SCAN mode), m/z=29, 31, 32, 43, 45, 60 (SIM mode)

TABLE 1

| | Negative | | | | | | | Analysis result of | |
|---|---|---|---|---|---|---|---|---|---|
| | electrode | | | | | | | electrolytic solution | |
| | LSX | Electrolytic solution (at the time of preparation) | | | | | | Carboxylic acid | Alcohol |
| | Si ratio | Ester | | Carboxylic acid | | Alcohol | | compound B | compound A |
| Battery | [mass %] | compound C | Vol % | compound B | ppm | compound A | ppm | ppm | ppm |
| A1 | 55 | methyl acetate | 2 | acetic acid | 2 | methanol | 2 | 20 | 19 |
| A2 | 55 | methyl acetate | 5 | acetic acid | 5 | methanol | 5 | 24 | 29 |
| A3 | 55 | methyl acetate | 45 | acetic acid | 20 | methanol | 25 | 32 | 41 |
| A4 | 55 | methyl acetate | 55 | acetic acid | 35 | methanol | 40 | 57 | 60 |
| A5 | 55 | ethyl acetate | 20 | acetic add | 40 | ethanol | 35 | 62 | 45 |
| A6 | 55 | propyl acetate | 20 | acetic add | 25 | propanol | 35 | 33 | 44 |
| A7 | 55 | methyl propionate | 20 | propionic acid | 40 | methanol | 30 | 60 | 55 |
| A8 | 55 | methyl acetate | 20 | — | — | methanol | 20 | 35 | 46 |
| B1 | 55 | — | — | — | — | — | — | — | — |
| B2 | 55 | methyl acetate | 10 | — | — | — | — | 10 | 12 |
| B3 | 25 | methyl acetate | 25 | acetic acid | 31 | methanol | 37 | 52 | 61 |

The batteries A1 to 8 of Examples 1 to 8 and the batteries B1 to B3 of Comparative Examples 1 to 3 were evaluated as follows. The evaluation results are shown in Table 2.

[Battery Capacity]

A constant-current charge was performed at a current of 0.3 It (800 mA) until the voltage reached 4.2 V, and then a constant-voltage charge was performed at a voltage of 4.2 V until the current reached 0.015 It (40 mA). This was followed by a constant-current discharge at 0.3 It (800 mA) until the voltage reached 2.75 V. The discharge capacity D1 at this time was measured as a battery capacity.

[Cycle Retention Ratio]

A constant-current charge was performed at a current of 0.3 It (800 mA) until the voltage reached 4.2 V and then a constant-voltage charge was performed at a voltage of 4.2 V until the current reached 0.015 It (40 mA). This was followed by a constant-current discharge at 0.3 It (800 mA) until the Voltage reached 2.75 V.

With the rest time between charge and discharge set to 10 minutes, charge and discharge were repeated under the charge and discharge conditions as mentioned above. The ratio of the discharge capacity at the 300^{th} cycle to the discharge capacity at the 1^{st} cycle was calculated as a cycle retention ratio. The charge and discharge were performed in a 25° C. environment.

[Storage Capacity Retention Ratio]

The batteries after the initial charge were left to stand for a long period of time (one month) in a 60° C. environment. After the time had passed, the batteries were subjected to a constant-current discharge at 0.3 It (800 mA) until the voltage reached 2.75 in a 25° C. environment, to measure a discharge capacity. The ratio of the discharge capacity to the initial charge capacity was calculated as a storage capacity retention ratio.

TABLE 2

| | | 300 cycles | 60° C. for 1 month storage |
|---|---|---|---|
| | Charge capacity | retention ratio | capacity retention ratio |
| Battery | [mAh] | [%] | [%] |
| A1 | 2610 | 77 | 76 |
| A2 | 2639 | 85 | 95 |
| A3 | 2666 | 82 | 94 |
| A4 | 2650 | 80 | 94 |
| A5 | 2644 | 81 | 92 |
| A6 | 2632 | 80 | 91 |
| A7 | 2635 | 82 | 91 |
| A8 | 2622 | 78 | 80 |
| B1 | 2636 | 62 | 85 |
| B2 | 2590 | 63 | 62 |
| B3 | 1742 | 51 | 69 |

Table 2 shows that the batteries A1 to A8, in which in addition to the ester compound C, the alcohol compound A or the carboxylic acid compound B constituting the ester compound C was added to the electrolytic solution in advance, were non-aqueous electrolyte secondary batteries having a high capacity and a high cycle retention ratio, as well as excellent high-temperature storage characteristics.

In the battery B1 containing no ester compound C, the cycle retention ratio was low. In the battery B2 containing the ester compound C, the cycle retention ratio was slightly improved as compared to the battery B1. The battery B2, however, was far inferior to the battery B1 in terms of the high-temperature storage characteristics. This was presumably because exposure to strong alkali and high temperatures caused the decomposition reaction of the ester compound C to he accelerated.

In the battery B3, in which the silicon ratio in the LSX was low the capacity was considerably smaller than that of the other batteries A1 to A8, B1, and B2.

In contrast, the batteries A1 to A8 showed a large capacity and a high cycle retention ratio, and were excellent in high-temperature storage characteristics. This was presumably because, due to the presence of the alcohol con pound A or the carboxylic acid compound B in the electrolytic solution, the equilibrium of the esterification reaction had shifted to the formation side of the ester compound C. As a result, the decomposition reaction of the ester compound C was difficult to proceed even in a high temperature environment, hardly deteriorating the storage characteristics.

### INDUSTRIAL APPLICABILITY

According to the non-aqueous electrolyte secondary battery of the present invention, a non-aqueous electrolyte secondary battery having a high capacity and excellent high-temperature storage characteristics can be provided. The non-aqueous electrolyte secondary battery of the present invention useful as a main power source for mobile communication devices, portable electronic devices, and others.

### REFERENCE SIGNS LIST

4: flame body

5: sealing plate

6: battery case

9: electrode group

11: negative electrode lead

13: negative electrode terminal

14: positive electrode lead

20: LSX particle

21: lithium silicate phase

22: silicon particle

23: base particle

24: conductive layer

25: particle containing element Me

1. A non-aqueous electrolyte secondary battery, comprising
a positive electrode, a separator, a negative electrode facing the positive electrode with the separator interposed between the positive electrode and the negative electrode, and an electrolytic solution including a solvent and an electrolyte,
the negative electrode including a negative electrode material containing a lithium silicate phase and silicon particles dispersed in the lithium silicate phase,
the silicon particles being contained in the negative electrode material in an amount of 30 mass % or more, relative to a total mass of the lithium silicate phase and the silicon particles,
the electrolytic solution containing an ester compound C of an alcohol compound A and a carboxylic acid compound B, and containing at least one of the alcohol compound A and the carboxylic acid compound B in an amount of 15 ppm or more, relative to a mass of the electrolytic solution.

2. The non-aqueous electrolyte secondary battery of claim 1, wherein the alcohol compound A is contained in an amount of 15 to 1000 ppm, relative to the mass of the electrolytic solution.

3. The non-aqueous electrolyte secondary battery of claim 1, wherein the carboxylic acid compound B is contained in an amount of 15 to 1000 ppm, relative to the mass of the electrolytic solution.

4. The non-aqueous electrolyte secondary battery of claim 1, wherein the ester compound C is contained in an amount of 1 to 80%, relative to a volume of the electrolytic solution.

5. The non-aqueous electrolyte secondary battery of claim 1, wherein the alcohol compound A includes at least one selected from the group consisting of monoalcohols having 1 to 3 carbon atoms.

6. The non-aqueous electrolyte secondary battery of claim 5, wherein the alcohol compound A includes methanol.

7. The non-aqueous electrolyte secondary battery of claim 1, wherein the carboxylic acid compound B includes at least one selected from the group consisting of monocarboxylic acids having 2 to 4 carbon atoms.

8. The non-aqueous electrolyte secondary batter-of claim 7, wherein the carboxylic acid compound B includes acetic acid.

9. The non-aqueous electrolyte secondary battery of claim 1, wherein the lithium silicate phase has a composition represented by a formula: LiySiOz, where 0<y≤4, and 0.2≤z≤5.
